(19) United States
(12) Patent Application Publication
(10) Pub. No.: US 2015/0213772 A1
(43) Pub. Date: Jul. 30, 2015

(54) DISPLAY PANEL AND DRIVING METHOD THEREOF

(71) Applicant: AU OPTRONICS CORP., Hsin-Chu (TW)

(72) Inventors: Yu-Hung TUNG, HSIN-CHU (TW); Kai-Yuan SIAO, HSIN-CHU (TW)

(21) Appl. No.: 14/314,480

(22) Filed: Jun. 25, 2014

(30) Foreign Application Priority Data
Jan. 27, 2014 (TW) 103102960

(51) Int. Cl. G09G 3/36

(52) U.S. Cl. CPC G09G 3/3614; G09G 3/3607; G09G 3/3659; G09G 2330/021; G09G 2320/0257; G09G 2320/0233; G09G 2310/0213; G09G 2300/0443; G09G 2300/0452

(57) ABSTRACT

A display panel and a driving method thereof are provided. The display panel includes scan lines, data lines, and a pixel array. The scan lines are configured to sequentially transmit scan signals. The data lines are configured to transmit data signals. The pixel array includes a first column pixel unit and a second column pixel unit each of which includes pixel units. Each pixel unit in the first column pixel unit and the second column pixel unit includes sub-pixels with different colors. When the scan signals are sequentially transmitted to the pixel units, the data lines transmit the corresponding data signals to the sub-pixels with the same color in odd-numbered rows of the first column pixel unit and the sub-pixels with the same color in even-numbered rows of the second column pixel unit, such that the sub-pixels have the same polarity based on the corresponding data signals.

### RELATED APPLICATIONS

This application claims priority to Taiwan Application Serial Number 103102960, filed Jan. 27, 2014, which is herein incorporated by reference.

### BACKGROUND

1. Field of Disclosure

The disclosure relates to a display panel and a driving method thereof, and more particularly to a display panel with dummy data lines and a driving method thereof.

2. Description of Related Art

Most of common display devices, such as common liquid crystal displays (LCD) in the market, adopt a column inversion driving method for driving display panels therein to save dynamic power, such that each sub-pixel in the respective display panels inverts its polarity sequentially based on driving signals.

However, for a general display device applying the column inversion driving method, at each time of image update, a V-line mura phenomenon often occurs accompanying with the polarity inversion of the driving signals.

Although a polarity staggering (Zigzag) method can be used to drive a display panel for improving the problem of V-line mura phenomenon, yet adjacent sub-pixels in the display panel have to receive the driving signals of which the polarities are consistently inverted, such that the same data line linking the adjacent sub-pixels needs to keep on inverting the transmitted driving signals, thus causing the display device to consume a lot of power.

### SUMMARY

One aspect of the disclosure relates to a display panel. In one embodiment of the disclosure, the display panel includes scan lines, data lines and a pixel array. The scan lines are configured to sequentially transmit scan signals. The data lines are configured to transmit data signals. The pixel array includes a first column pixel unit and a second column pixel unit. Each of the first column pixel unit and the second column pixel unit includes pixel units, and each of the pixel units includes sub-pixels with different colors. When the scan signals are transmitted sequentially to the pixel units, the data lines transmit the corresponding data signals to the sub-pixels with the same color in odd-numbered rows of the first column pixel unit and the sub-pixels with the same color in even-numbered rows of the second column pixel unit, such that the sub-pixels have the same polarity based on the corresponding data signals.

Another aspect of the disclosure relates to a driving method of a display panel. In one embodiment of the disclosure, the driving method includes the following steps. At first, scan signals are sequentially transmitted to the pixel units. Then, the corresponding data signals are transmitted to the sub-pixels with the same color in odd-numbered rows of the first column pixel unit and the sub-pixels with the same color in even-numbered rows of the second column pixel unit. Then, the sub-pixels with the same color generate the same polarity based on the corresponding data signals.

Summing the above, through the aforementioned embodiments, the dummy data lines and the data lines are used to drive the sub-pixels with the same color in the pixel units, such that the sub-pixels coupled to the same dummy data line or the same data line receive the same driving signal and have the same polarity. In addition, by utilizing the arrangement of the pixel units in the pixel array of the disclosure, the number of polarity conversion times that the data signals perform color compensation for the red sub-pixels, the green sub-pixels and the blue sub-pixels can be reduced. When the operation of column inversion is performed, power saving for a pure color image can be achieved, and the problem of V-line mura phenomenon can be further resolved.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1A illustrates a schematic diagram of a display panel according to one embodiment of the disclosure;

FIG. 1B illustrates a schematic diagram showing the operation of the display panel of FIG. 1A;

FIG. 10 illustrates an operational timing diagram of the display panel of

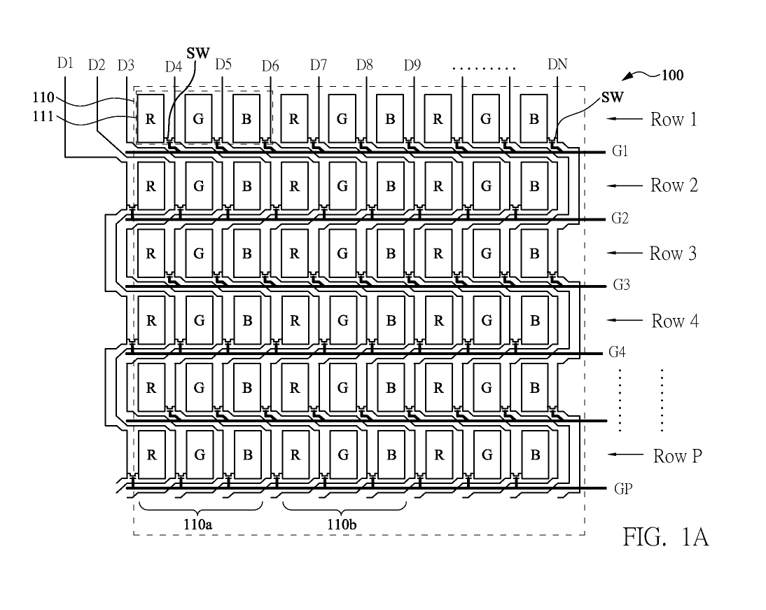

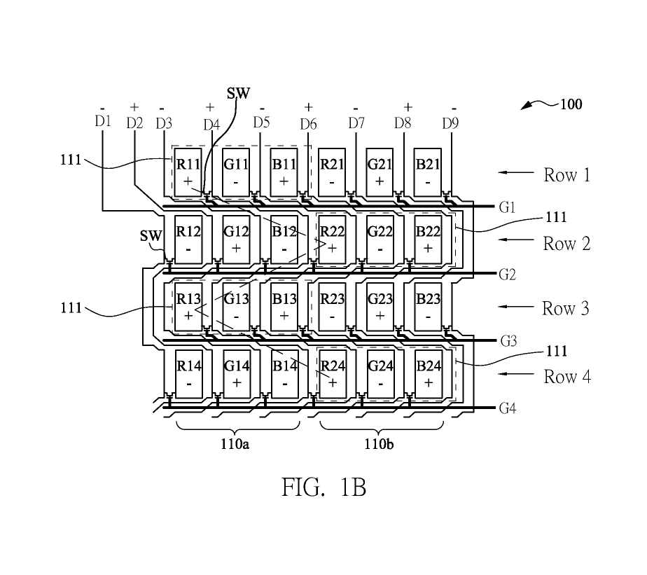

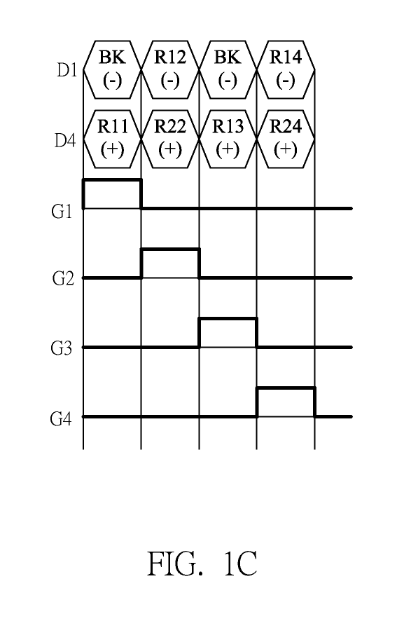

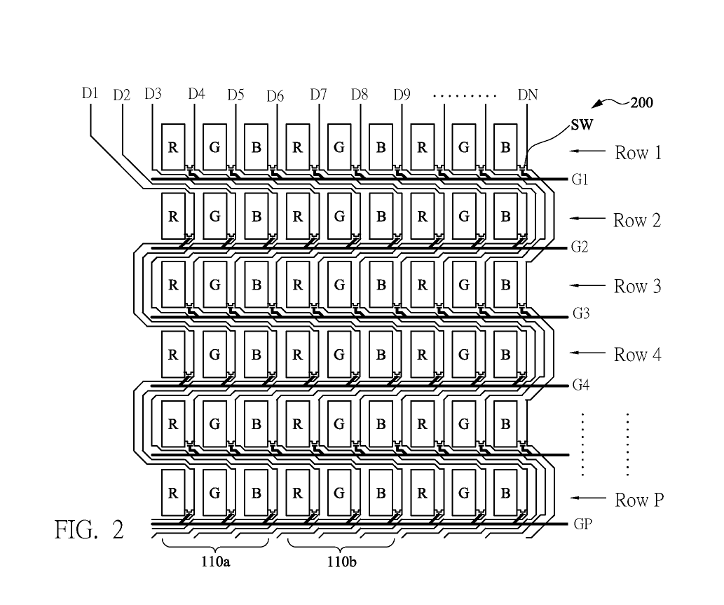

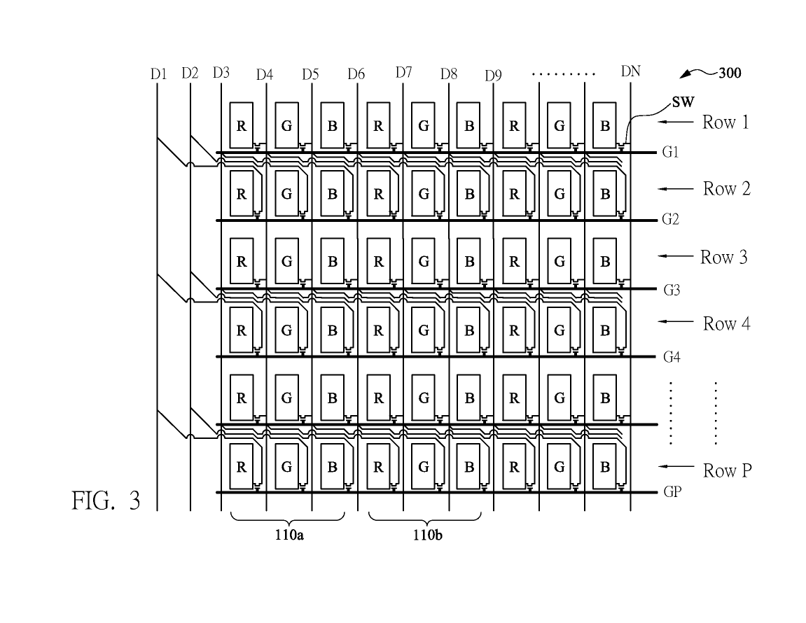

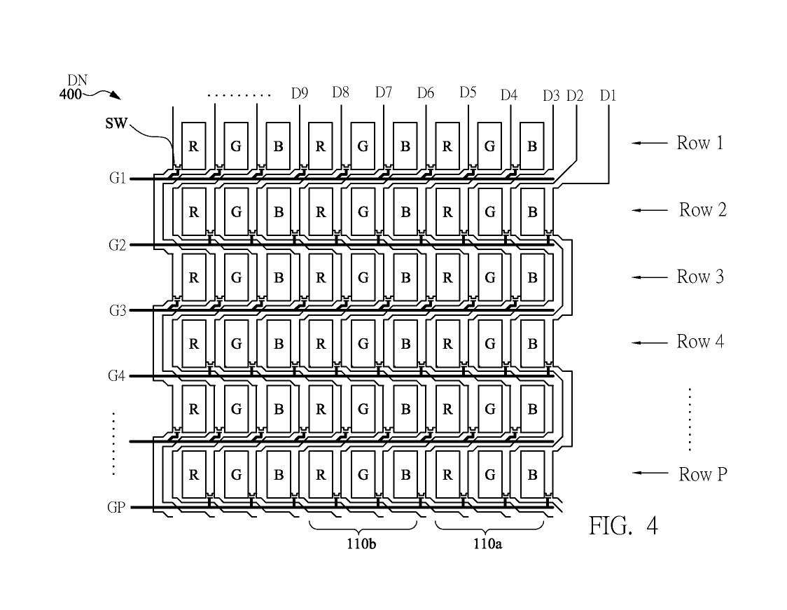

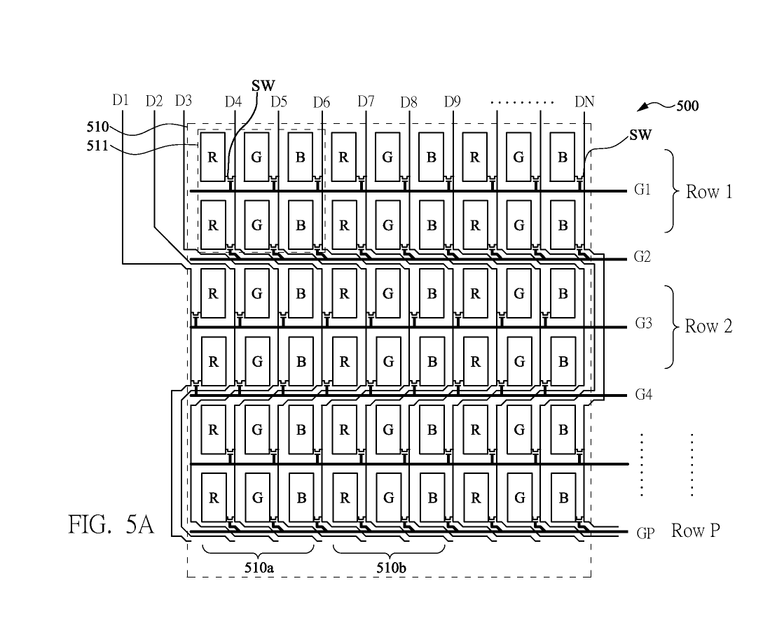

FIG. 1B;

FIG. 2 illustrates a schematic diagram of a display panel according to another embodiment of the disclosure;

FIG. 3 illustrates a schematic diagram of a display panel according to another embodiment of the disclosure;

FIG. 4 illustrates a schematic diagram of a display panel according to another embodiment of the disclosure;

FIG. 5A illustrates a schematic diagram of a display panel according to another embodiment of the disclosure;

FIG. 5B illustrates a schematic diagram showing the operation of the display panel of FIG. 5A;

FIG. 5C illustrates an operational timing diagram of the display panel of FIG. 5B; and

FIG. 6 illustrates a flowchart diagram of a driving method of a display panel according to one embodiment of the disclosure.

### DETAILED DESCRIPTION

In the following description, the disclosure will be explained with reference to embodiments thereof. However, these embodiments are not intended to limit the disclosure to any specific environment, applications or particular implementations described in these embodiments. Therefore, the description of these embodiments is only for the purpose of illustration rather than to limit the disclosure. In the following embodiments and attached drawings, elements not directly related to the disclosure are omitted from depiction; and the dimensional relationships among individual elements in the attached drawings are illustrated only for ease of understanding, but not to limit the actual scale.

It will be understood that, although the terms “first” and “second” may be used herein to describe various elements, components, regions, layers and/or sections, these elements, components, regions, layers and/or sections should not be limited by these terms. These terms are only used to distinguish one element, component, region, layer or section from another.

In the following description and claims, the term “coupled” along with their derivatives, may be used. In particular embodiments, “coupled” may be used to indicate that two or more elements are in direct physical or electrical contact with each other, or may also mean that two or more elements may not be in direct contact with each other. “Coupled” may still be used to indicate that two or more elements cooperate or interact with each other.

One embodiment of the disclosure is directed to a display panel 100, as schematically illustrated in FIG. 1A. In actual applications, the display panel may be applied to a display device (not shown), and the display device may include a data unit (not shown), a scanning unit (not shown) and the display panel 100. The data unit and the scanning unit are configured to generate data signals and scan signals respectively for the display panel 100 to display an image.

In the embodiment, the display panel 100 includes dummy data lines D1-D3, data lines D4-DN, scan lines G1-GP and a pixel array 110. The scan lines G1-GP are configured to sequentially transmit the scan signals to the pixel array 110, where P is an integer greater than 1. In addition, the dummy data lines D1-D3 and the data lines D4-DN are configured to respectively transmit the data signals to the pixel array 110, where N is an integer greater than 4.

As shown in FIG. 1A, the pixel array 110 includes a first column pixel unit 110a and a second column pixel unit 110b. The first column pixel unit 110a and the second column pixel unit 110b include pixel units 111 respectively, and each pixel unit 111 includes sub-pixels with different colors, in which the sub-pixels include red sub-pixels R, green sub-pixels G and blue sub-pixels B. For convenient and clear description, FIG. 1A exemplarily illustrates only one pixel unit 111, but the scope of the disclosure is not limited thereto.

In one embodiment, the pixel unit 111 further includes switching elements SW. Each switching element SW is turned on based on the corresponding scan signals, such that the sub-pixels receive the data signals respectively through the switching elements SW.

In addition, as shown in FIG. 1A, each switching element SW in the odd-numbered rows of the first column pixel unit 110a and the second column pixel unit 110b is arranged at the right side of the corresponding sub-pixel. On the other hand, each switching element SW in the even-numbered rows of the first column pixel unit 110a and the second column pixel unit 110b is arranged at the left side of the corresponding sub-pixel. It should be noted that each switching elements SW may also be arranged at the left side of the corresponding sub-pixel in the odd-numbered rows or at the right side of the corresponding sub-pixel in the even-numbered rows in an opposite manner.

In one embodiment, the dummy data lines D1-D3 are coupled to the corresponding switching elements SW respectively along the left side of the corresponding sub-pixels in the even-numbered rows of the first column pixel unit 110a. In addition, the data lines D4-DN are coupled to the corresponding switching elements SW respectively along the right side of the corresponding sub-pixels in the odd-numbered rows and the left side of the corresponding sub-pixels in the even-numbered rows.

In operation, when the scan signals are sequentially transmitted to the pixel units 111, the data lines D4-DN transmit the corresponding data signals to the sub-pixels with the same color in the odd-numbered rows of the first column pixel unit 110a and the sub-pixels with the same color in the even-numbered rows of the second column pixel unit respectively, such that the sub-pixels have the same polarity based on the corresponding data signals.

In addition, the switching elements SW in the even-numbered rows of the first column pixel unit 110a are turned on based on the scan signals transmitted by the corresponding scan lines G1-GP, so as to receive the data signals from the dummy data lines D1-D3. The dummy data lines D1-D3 are sequentially arranged at the left side of the data lines D4-DN. The dummy data lines D1-D3 are configured to transmit the corresponding data signals to the sub-pixels with the same color in even-numbered rows of the first column pixel unit 110a, such that the sub-pixels have the same polarity based on the corresponding data signals.

For exemplary purpose, the following embodiments are described with an example in which N is 9 and P is 4, but are not limited thereto.

In one embodiment, as shown in FIG. 1B, the scan lines G1-G4 are sequentially transmit the scan signals to the corresponding switching elements SW, such that the corresponding switching elements SW are sequentially turned on based on the scan signals. Meanwhile, the dummy data lines D1-D3 and the data lines D4-D9 transmit the data signals respectively to the pixel array 110 to drive the sub-pixels of the pixel units 111.

For example, in the case of red sub-pixels, the first column pixel unit 110a includes red sub-pixels R11-R14, and the second column pixel unit 110b includes red sub-pixels R21-R24. The sub-pixels R11 and R13 in the odd-numbered rows of the first column pixel unit 110a are coupled to the sub-pixels R22 and R24 in the even-numbered rows of the second column pixel unit 110b by the data line D4. In addition, the dummy data line D1 is coupled to the red sub-pixels R12 and R14 in the even-numbered rows of the first column pixel unit 110a.

As shown in FIG. 1B, when the scan lines G1-G4 sequentially turn on the corresponding switching elements SW, the dummy data line D1 transmits the data signals to the red sub-pixels R12 and R14 in the first column pixel unit 110a, and the data line D4 transmits the data signals to the red sub-pixels R11, R13 in the first column pixel unit 110a and the red sub-pixels R22 and R24 in the second column pixel unit 110b.

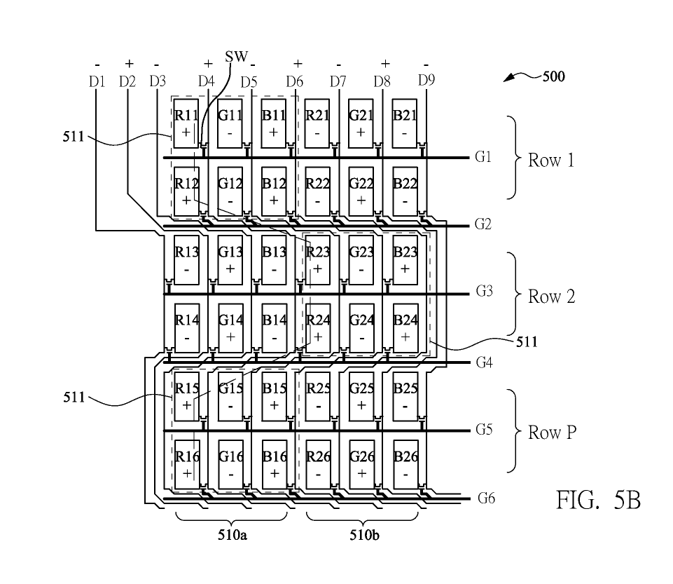

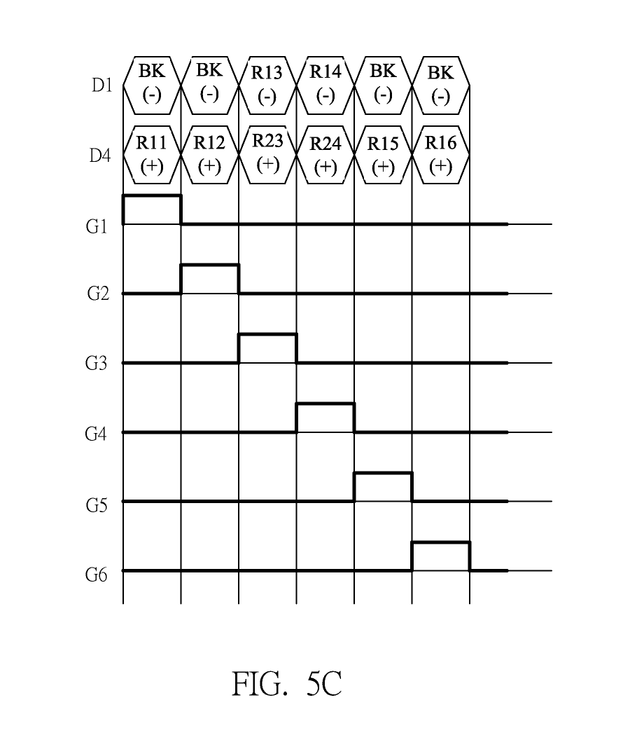

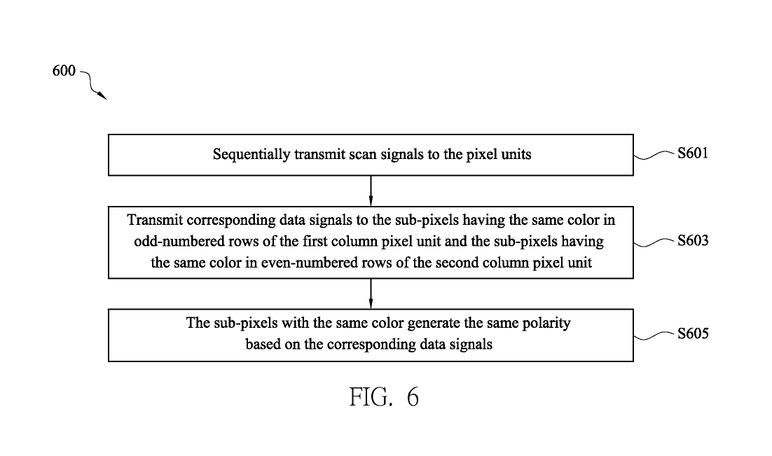

Please also refer to FIG. 10, FIG. 10 illustrates an operational timing diagram of the display panel 100 of FIG. 1B.

At first, when the scan line G1 transmits the scan signal to the corresponding switching element SW, the data line D4 transmits the data signal to the red sub-pixel R11. When the scan line G1 transmits the scan signal to the corresponding switching element SW, the dummy data line D1 does not need to generate a corresponding pixel data signal, and in such a condition, the dummy data line D1 generates a dummy data signal BK.

Then, when the scan line G2 transmits the scan signal to the corresponding switching element SW, the dummy data line D1 transmits the data signal to the red sub-pixel R12, and the data line D4 transmits the data signal to the red sub-pixel R22.

Then, when the scan line G3 transmits the scan signal to the corresponding switching element SW, the dummy data line D1 generates the dummy data signal BK, and the data line D4 transmits the data signal to the red sub-pixel R13.

Thereafter, when the scan line G4 transmits the scan signal to the corresponding switching element SW, the dummy data line D1 transmits the data signal to the red sub-pixel R14, and the data line D4 transmits the data signal to the red sub-pixel R24.

In other words, the dummy data line D1 sequentially transmits the dummy data signal BK, the data signal of the red sub-pixel R12, the data signal of the red sub-pixel R13 and the data signal of the red sub-pixel R14 based on the scan signals of the scan lines G1-G4. In addition, the data line D4 sequentially transmits the data signals to the red sub-pixels R11, R22, R13 and R14 based on the scan signals of the scan lines G1-G4.

In another embodiment, the dummy data signal and the data signals include a positive polarity and a negative polarity. For example, as shown in FIG. 1B, the data signals transmitted by the dummy data line D1 have the negative polarity, and the dummy data line D1 is coupled to the red sub-pixels R12 and R14. In this condition, the polarities of the red sub-pixels R12, R14 are negative. On the other hand, the data line D4 is coupled to the red sub-pixels R11, R22, R13 and R24, and therefore, the polarities of the red sub-pixels R11, R22, R13 and R24 are all positive.

In addition, when the display panel 100 is driven again, the scan lines G1-G4 sequentially transmit the scan signals to the corresponding switching elements SW again, such that the switching elements SW are sequentially turned on based on the scan signals. At this time, the polarities of the data signals transmitted by the dummy data line D1 are opposite to those of the dummy data signals BK, such that the polarities of the red sub-pixels R12 and R14 coupled to the dummy data line D1 are inverted from negative to positive. Likewise, the data line D4 is coupled to the red sub-pixels R11, R22, R13 and R24. The data signals transmitted by the data line D4 are inverted from positive to negative, such that the polarities of the red sub-pixels R11, R22, R13 and R24 are inverted from positive to negative.

It should be noted that the quantities of the aforementioned dummy data lines, data lines, scan lines, pixel units and sub-pixels are merely used for exemplary purposes, but do not intend to limit the scope of the disclosure. In addition, the green sub-pixels G and the blue sub-pixels B of the display panel 100 may also be configured and operated in a similar manner, so as to generate the aforementioned same or similar driving effects, and thus are not described herein again.

Another embodiment of the disclosure is directed to a display panel 200 as illustrated in FIG. 2. The display panel 200 is similar to the display panel 100, and includes the same components as the display panel 100.

As shown in FIG. 2, the arrangement of the dummy data lines D1-D3 and data lines D4-DN in the display panel 200 is different from that of the dummy data lines D1-D3 and data lines D4-DN in the display panel 100.

In one embodiment, the switching elements SW in the odd-numbered rows of the first column pixel unit 110a and the second column pixel unit 110b are arranged at the right side of the corresponding sub-pixels. On the other hand, the switching elements SW in the even-numbered rows of the first column pixel unit 110a and the second column pixel unit 110b are arranged at the left side of the corresponding sub-pixels. It should be noted that the switching elements SW may be arranged at different positions corresponding to the arrangement of the data lines and the dummy data lines, and that the aforementioned arranged positions of the switching elements SW are merely for exemplary purposes, but do not intend to limit the scope of the disclosure. Any positional arrangement of the switching elements SW corresponding to the data lines and the dummy data lines shall be in the scope of protection of the disclosure.

As shown in FIG. 2, the difference between the display panel 200 and the display panel 100 is that, the dummy data lines D1-D3 and the data lines D4-DN of the display panel 200 are coupled to the corresponding switching elements SW along the right side of the corresponding sub-pixels.

In operation, the operating method of the display panel 200 is similar to that of the display panel 100, and thus is not described herein again.

Another embodiment of the disclosure is a display panel 300 as illustrated in FIG. 3. The display panel 300 is similar to the display panel 100, and includes the same components as the display panel 100.

As shown in FIG. 3, the arrangement of the dummy data lines D1-D3 and data lines D4-DN in the display panel 300 is different from that of the dummy data lines D1-D3 and data lines D4-DN in the display panel 100. In addition, the switching elements SW in the first column pixel unit 110a and the second column pixel unit 110b are arranged at the right side of the corresponding sub-pixels.

The difference between the display panel 300 and the display panel 100 is that, the dummy data lines D1-D3 of the display panel 300 are arranged along the left side of the corresponding sub-pixels respectively, and are coupled to the corresponding switching elements SW respectively along the upper side of the corresponding sub-pixels. In addition, the data lines D4-DN of the display panel 300 are coupled to the corresponding switching elements SW along the right side of the corresponding sub-pixels.

In operation, the operating method of the display panel 300 is similar to that of the display panel 100, and thus is not described herein again.

Another embodiment of the disclosure is a display panel 400 as illustrated in FIG. 4. The display panel 400 is similar to the display panel 100, and includes the same components as the display panel 100.

As shown in FIG. 4, the dummy data lines D1-D3 are sequentially arranged at the right side of the data lines D4-DN. The arrangement of the dummy data lines D1-D3 and data lines D4-DN in the display panel 400 is different from that of the dummy data lines D1-D3 and data lines D4-DN in the display panel 100.

In one embodiment, the switching elements SW in the odd-numbered rows of the first column pixel unit 110a and the second column pixel unit 110b are arranged at the left side of the corresponding sub-pixels. On the other hand, the switching elements SW in the even-numbered rows of the first column pixel unit 110a and the second column pixel unit 110b are arranged at the right side of the corresponding sub-pixels.

The difference between the display panel 400 and the display panel 100 is that, the dummy data lines D1-D3 of the display panel 400 are coupled to the corresponding switching elements SW respectively along the right side of the corresponding sub-pixels in the even-numbered rows of the first column pixel unit 110a. In addition, the data lines D4-DN of the display panel 400 are coupled to the corresponding switching elements SW respectively along the left side of the corresponding sub-pixels in the odd-numbered rows and along the right side of the corresponding sub-pixels in the even-numbered rows.

In operation, the operating method of the display panel 400 is similar to that of the display panel 100, and therefore is not repeated herein.

Another embodiment of the disclosure is a display panel 500 as illustrated in FIG. 5A. The display panel 500 is similar to the display panel 100, and includes the same components as the display panel 100.

As shown in FIG. 5A, the display panel 500 includes dummy data lines D1-D3, data lines D4-DN, scan lines G1-GP and a pixel array 510. The scan lines G1-GP are configured to sequentially transmit the scan signals to the pixel array 510, where P is an integer greater than 1. In addition, the dummy data lines D1-D3 and the data lines D4-DN are configured to respectively transmit the data signals to the pixel array 510, where N is an integer greater than 4.

In one embodiment, the pixel array 510 includes a first column pixel unit 510a and a second column pixel unit 510b. The first column pixel unit 510a and the second column pixel unit 510b include pixel units 511 respectively, and each pixel unit 511 includes sub-pixels with different colors, in which the sub-pixels include red sub-pixels R, green sub-pixels G and blue sub-pixels B.

The difference between the display panel 500 and the display panel 100 is that, each pixel unit 111 of the display panel 100 includes only a red sub-pixel R, a green sub-pixel G and a blue sub-pixel B, whereas each pixel unit 511 of the display panel 500 includes two red sub-pixels R, two green sub-pixels G and two blue sub-pixels B. For convenient and clear description, FIG. 5A exemplarily illustrates only one pixel unit 511, but the scope of the disclosure is not limited thereto.

In one embodiment, the pixel unit 511 further includes switching elements SW. Each switching element SW is turned on based on the corresponding scan signals, such that the sub-pixels receive the data signals respectively through the switching elements SW.

In addition, as shown in FIG. 5A, each switching element SW in the odd-numbered rows of the first column pixel unit 510a and the second column pixel unit 510b is arranged at the right side of the corresponding sub-pixels. On the other hand, each switching element SW in the even-numbered rows of the first column pixel unit 510a and the second column pixel unit 510b is arranged at the left side of the corresponding sub-pixels.

In one embodiment, the sub-pixels 511 with the same color in the odd-numbered rows of the first column pixel unit 510a are mutually coupled, and the sub-pixels 511 with the same color in the even-numbered rows of the second column pixel unit 510b are mutually coupled. In addition, the sub-pixels 511 with the same color in the even-numbered rows of the first column pixel unit 510a are mutually coupled. It should be noted that, the arrangement of the display panel 500 is similar to the display panel 100, and thus is not described herein again.

For exemplary purpose, the following embodiments are described in an example in which N is 9 and P is 6, but are not limited thereto.

Referring to FIG. 5B, in the case of red sub-pixels, the red sub-pixels R11, R12, R15 and R16 in the odd-numbered rows of the first column pixel unit 510a are mutually coupled by the data line D4. In addition, the red sub-pixels R23 and R24 in the even-numbered row of the second column pixel unit 510b are coupled by the data line D4.

In other words, the red sub-pixels R11, R12, R15 and R16 in the odd-numbered rows of the first column pixel unit 510a are coupled to the red sub-pixels R23 and R24 in the even-numbered row of the second column pixel unit 510b by the data line D4. Further, the red sub-pixels R13 and R14 in the even-numbered row of the first column pixel unit 510a are coupled by the dummy data line D1.

In operation, the scan lines G1-GP sequentially transmit the scan signals to the corresponding switching elements SW, such that the switching elements SW are sequentially turned on based on the scan signals. At this time, the data lines D4-D9 transmit the data signals respectively to the first column pixel unit 510a and the second column pixel unit 510b to drive the pixel units 511 in the first column pixel unit 510a and the second column pixel unit 510b.

Please also refer to FIG. 5C, FIG. 5C illustrates an operational timing diagram of the scan signals and the data signals of the display panel 500.

At first, when the scan line G1 transmits the scan signal to the corresponding switching element SW, the data line D4 transmits the data signal to the red sub-pixel R11. When the scan line G1 transmits the scan signal to the corresponding switching element SW, the dummy data line D1 does not need to generate a corresponding pixel data signal, and in such a condition, the dummy data line D1 generates a dummy data signal BK.

Then, when the scan line G2 transmits the scan signal to the corresponding switching element SW, the dummy data line D1 generates the dummy data signal BK, and the data line D4 transmits the data signal to the red sub-pixel R12.

Then, when the scan line G3 transmits the scan signal to the corresponding switching element SW, the dummy data line D1 transmits the data signal to the red sub-pixel R13, and the data line D4 transmits the data signal to the red sub-pixel R23.

Then, when the scan line G4 transmits the scan signal to the corresponding switching element SW, the dummy data line D1 transmits the data signal to the red sub-pixel R14, and the data line D4 transmits the data signal to the red sub-pixel R24.

Then, when the scan line G5 transmits the scan signal to the corresponding switching element SW, the dummy data line D1 generates the dummy data signal BK, and the data line D4 transmits the data signal to the red sub-pixel R15.

Thereafter, when the scan line G6 transmits the scan signal to the corresponding switching element SW, the dummy data line D1 generates the dummy data signal BK, and the data line D4 transmits the data signal to the red sub-pixel R16.

In other words, the dummy data line D1 transmits the dummy data signal BK, the dummy data signal BK, the data signal of the red sub-pixel R13, the data signal of the red sub-pixel R14, the dummy data signal BK and the dummy data signal BK respectively based on the scan lines G1-G6. In addition, the data line D4 transmits the data signals to the red sub-pixels R11, R12, R23, R24, R15 and R16 respectively based on the scan signals of the scan lines G1-G6.

In another embodiment, the dummy data signals and the data signals include a positive polarity and a negative polarity. For example, as shown in FIG. 5B, the dummy data signals BK transmitted by the dummy data line D1 have the negative polarity, and the dummy data line D1 is coupled to the red sub-pixels R13 and R14. In this condition, the polarities of the red sub-pixels R13 and R14 are negative. On the other hand, the data line D4 is coupled to the red sub-pixels R11, R12, R23, R24, R15 and R16. The data signals transmitted by the data line D4 are positive polarized, and therefore, the polarities of the red sub-pixels R11, R12, R23, R24, R15 and R16 are all positive.

In addition, when the display panel 500 is driven again, the scan lines G1-G6 sequentially transmit the scan signals to the corresponding switching elements SW again, such that the switching elements SW are sequentially turned on based on the scan signals. At this time, the polarities of the data signal transmitted by the dummy data line D1 and the dummy data signals BK are changed, such that the polarities of the red sub-pixels R13 and R14 coupled to the dummy data line D1 are inverted from negative to positive. Likewise, the data line D4 is coupled to the red sub-pixels R11, R12, R23, R24, R15 and R16. The data signals transmitted by the data line D4 are inverted from positive to negative, such that the polarities of the red sub-pixels R11, R12, R23, R24, R15 and R16 are inverted from positive to negative.

It should be noted that the quantities of the aforementioned dummy data lines, data lines, scan lines, pixel units and sub-pixels are merely for exemplarily purposes, but do not intend to limit the scope of the disclosure. In addition, the green sub-pixels G and the blue sub-pixels B of the display panel 500 may also be configured and operated in a similar manner, so as to generate the aforementioned same or similar driving effects, and thus are not described herein again.

One embodiment of the disclosure is directed to a driving method 600 of a display panel, and a flowchart diagram thereof is illustrated in FIG. 6. The driving method 600 may be applied to the display panels 100, 200, 300, 400 and 500, but is not limited thereto.

First, in step S601, the scan signals are sequentially transmitted to the pixel units. Next, in step S603, the corresponding data signals are transmitted to the sub-pixels with the same color in the odd-numbered rows of the first column pixel unit and the sub-pixels with the same color in the even-numbered rows of the second column pixel unit. Last, in step S605, the sub-pixels with the same color generate the same polarity based on the corresponding data signals.

In another embodiment, step S603 includes the following step. The corresponding data signals are transmitted to the sub-pixels with the same color in the first row of the first column pixel unit and the sub-pixels with the same color in the second row of the second column pixel unit.

For example, as shown in FIG. 1B, each pixel unit 111 in the first row of the first column pixel unit 110a includes the red sub-pixel R11, the green sub-pixel G11 and the blue sub-pixel B11. In addition, each pixel unit 111 in the second row of the second column pixel unit 110b includes the red sub-pixel R22, the green sub-pixel G22 and the blue sub-pixel B22. When the scan lines G1-G2 sequentially transmit the scan signals to the switching elements SW, the data line D4 transmits the corresponding data signals to the red sub-pixels R11 and R22, the data line D5 transmits the corresponding data signals to the green sub-pixels G11 and G22, and the data line D6 transmits the corresponding data signals to the blue sub-pixels B11 and B22.

In another embodiment, step S603 includes the following step. The corresponding data signals are transmitted to the sub-pixels with the same color in the second row of the second column pixel unit and the sub-pixels with the same color in the third row of the first column pixel unit.

For example, as shown in FIG. 1B, each pixel unit 111 in the second row of the second column pixel unit 110b includes the red sub-pixel R22, the green sub-pixel G22 and the blue sub-pixel B22. In addition, each pixel unit 111 in the third row of the first column pixel unit 110a includes the red sub-pixel R13, the green sub-pixel G13 and the blue sub-pixel B13. When the scan lines G2-G3 sequentially transmit the scan signals to the switching elements SW, the data line D4 transmits the corresponding data signals to the red sub-pixels R22 and R13, the data line D5 transmits the corresponding data signals to the green sub-pixels G22 and G13, and the data line D6 transmits the corresponding data signals to the blue sub-pixels B22 and B13.

In another embodiment, step S601 further includes the following steps. The switching elements are sequentially turned on based on the scan signals, and the sub-pixels receive the data signals through the corresponding switching elements.

In another embodiment, the driving method 600 further includes the following step. The data signals generated by the dummy data lines are transmitted to to the sub-pixels with the same color in the even-numbered rows of the first column pixel unit, such that the sub-pixels generate the same polarity based on the corresponding data signals.

In another embodiment, the driving method 600 further includes the following step. The corresponding data signals are transmitted from one of the dummy data lines to a first sub-pixel in each even-numbered row of the first column pixel unit. For example, as shown in FIG. 1A, the aforementioned first sub-pixel can be among the red sub-pixel R, the green sub-pixel G and the blue sub-pixel B.

In another embodiment, the driving method 600 further includes the following step. The corresponding data signals are transmitted from one of the dummy data lines to a first sub-pixel in each odd-numbered row of the first column pixel unit and a first sub-pixel in each even-numbered row of the second column pixel unit. For example, as shown in FIG. 1A, the aforementioned first sub-pixel can be among the red sub-pixel R, the green sub-pixel G and the blue sub-pixel B.

In another embodiment, the driving method 600 further includes the following step. The corresponding data signals are transmitted from one of the dummy data lines to first sub-pixels in each odd-numbered row of the first column pixel unit and first sub-pixels in each even-numbered row of the second column pixel unit. For example, as shown in FIG. 5A, the aforementioned first sub-pixels can be among the red sub-pixels R, the green sub-pixels G and the blue sub-pixels B, and each pixel unit 511 includes two first sub-pixels.

Summing the above, through the aforementioned embodiments, the sub-pixels with the same color in the pixel units are driven by the dummy data lines and the data lines, such that the sub-pixels coupled to the same dummy data line or the same data line receive the same driving signal and have the same polarity. In addition, by utilizing the arrangement of the pixel units in the pixel array described in the disclosure, the number of polarity conversion times that the data signals perform color compensation for the red sub-pixels, the green sub-pixels and the blue sub-pixels can be reduced. When the operation of column inversion is performed, power saving for pure image can be achieved, and the problem of V-line mura phenomenon can be further resolved.

Although the disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the disclosure without departing from the scope or spirit of the disclosure. In view of the foregoing, it is intended that the disclosure cover modifications and variations of this disclosure provided they fall within the scope of the following claims.

What is claimed is:

1. A display panel, comprising:
a plurality of scan lines configured to sequentially transmit a plurality of scan signals;
a plurality of data lines configured to transmit a plurality of data signals;
a pixel array including a first column pixel unit and a second column pixel unit, each of the first column pixel unit and the second column pixel unit including a plurality of pixel units, each of the pixel units including sub-pixels with different colors;
wherein, when the scan signals are sequentially transmitted to the pixel units, the data lines transmit the corresponding data signals to the sub-pixels with the same color in odd-numbered rows of the first column pixel unit and the sub-pixels with the same color in even-numbered rows of the second column pixel unit, such that the sub-pixels have the same polarity based on the corresponding data signals.

2. The display panel of claim 1, wherein the pixel units include a plurality of switching elements, and the switching elements are turned on based on the corresponding scan signals, such that the sub-pixels receive the data signals respectively through the switching elements.

3. The display panel of claim 2, furthering comprising a plurality of dummy data lines configured to transmit the corresponding data signals to the sub-pixels with the same color in even-numbered rows of the first column pixel unit and the sub-pixels with the same color in odd-numbered rows of the second column pixel unit, such that the sub-pixels have the same polarity based on the corresponding data signals.

4. The display panel of claim 2, furthering comprising a plurality of dummy data lines, wherein the switching elements in even-numbered rows of the first column pixel unit are further configured to be turned on based on the scan signals, so as to receive the data signals from the dummy data lines.

5. The display panel of claim 3, wherein each of the pixel units comprises a first sub-pixel, and one of the dummy data lines is coupled to the first sub-pixel in the even-numbered rows of the first column pixel unit.

6. The display panel of claim 3, wherein each of the pixel units comprises a first sub-pixel, and the first sub-pixels in the odd-numbered rows of the first column pixel unit are coupled to the first sub-pixels in the even-numbered rows of the second column pixel unit.

7. The display panel of claim 3, wherein the pixel units comprise a plurality of first sub-pixels, and wherein the first sub-pixels in the odd-numbered rows of the first column pixel unit are mutually coupled, the first sub-pixels in the even-numbered rows of the second column pixel unit are mutually coupled, and the first sub-pixels in the odd-numbered rows of the first column pixel unit are coupled to the first sub-pixels in the even-numbered rows of the second column pixel unit.

8. The display panel of claim 3, wherein the data signals and dummy data signals generated by the dummy data lines comprise a first polarity and a second polarity different from the first polarity.

9. A method for driving a display panel as claimed in claim 1, the method comprising:
sequentially transmitting a plurality of scan signals to the pixel units;
transmitting the corresponding data signals to the sub-pixels with the same color in odd-numbered rows of the first column pixel unit and the sub-pixels with the same color in even-numbered rows of the second column pixel unit; and
the sub-pixels with the same color generating the same polarity based on the corresponding data signals.

10. The method of claim 9, wherein the step of transmitting the corresponding data signals to the sub-pixels with the same color in odd-numbered rows of the first column pixel unit and the sub-pixels with the same color in even-numbered rows of the second column pixel unit comprises:
sequentially transmitting the corresponding data signals to the sub-pixels with the same color in the first row of the first column pixel unit and the sub-pixels with the same color in the second row of the second column pixel unit.

11. The method of claim 9, wherein the step of transmitting the corresponding data signals to the sub-pixels with the same color in odd-numbered rows of the first column pixel unit and the sub-pixels with the same color in even-numbered rows of the second column pixel unit comprises:
sequentially transmitting the corresponding data signals to the sub-pixels with the same color in the second row of the second column pixel unit and the sub-pixels with the same color in the third row of a third column pixel unit.

12. The method of claim 9, wherein the pixel units comprises a plurality of switching elements, and the step of sequentially transmitting the scan signals to the pixel units further comprises:
sequentially turning on the switching elements based on the scan signals; and
the sub-pixels receiving the data signals respectively through the switching elements.

13. The method of claim 12, wherein the display panel further comprises a plurality of dummy data lines, and the method further comprises:
transmitting the data signals generated by the dummy data lines to the sub-pixels with the same color in even-numbered rows of the first column pixel unit, such that the sub-pixels generate the same polarity based on the corresponding data signals.

14. The method of claim 13, wherein each of the pixel units comprises a first sub-pixel, and the method further comprises:
transmitting the corresponding data signals from one of the dummy data lines to the first sub-pixels in the even-numbered rows of the first column pixel unit.

15. The method of claim 9, wherein each of the pixel units comprises a first sub-pixel, and the method further comprises:
transmitting the corresponding data signals from one of the data lines to the first sub-pixels in the odd-numbered rows of the first column pixel unit and the first sub-pixels in the even-numbered rows of the second column pixel unit.

16. The method of claim 9, wherein each of the pixel units comprises a plurality of first sub-pixels, and the method further comprises:
transmitting the corresponding data signals from one of the data lines to the first sub-pixels in the odd-numbered rows of the first column pixel unit and the first sub-pixels in the even-numbered rows of the second column pixel unit.
